(19) United States
(12) Patent Application Publication
(10) Pub. No.: US 2009/0248492 A1
(43) Pub. Date: Oct. 1, 2009

(54) INTERNET LEAD MANAGER AND OPTIMIZER

(75) Inventor: William M. Lloyd, Birmingham, MI (US)

Correspondence Address: BROOKS KUSHMAN P.C., 1000 TOWN CENTER, TWENTY-SECOND FLOOR, SOUTHFIELD, MI, 48075, US

(73) Assignee: SALEZTRACK LLC, Troy, MI (US)

(21) Appl. No.: 12/267,219

(22) Filed: Nov. 7, 2008

Related U.S. Application Data
(63) Continuation-in-part of application No. 12/058,667, filed on Mar. 29, 2008.

(51) Int. Cl. G06Q 30/00; G06Q 10/00

(52) U.S. Cl. 705/10; 705/9; 709/206

(57) ABSTRACT

A method of customer sales management over a computer network includes receiving customer sales management cadence data and communication tool data. The method includes receiving a sales lead identifier based on one or more tracked activities occurring over a computer network which identifies a priority associated with a sales lead. The sales lead identifier is associated with customer sales management cadence data for generating a schedule. A number of communication tools are generated for managing the sales lead through one or more communication channels. A series of communications are automatically outputted according to the schedule for facilitating customer generation and retention. The method is operated over a computer implemented system for customer sales management having at least one server communicating with at least one client terminal over a computer network. Furthermore, a computer program product has computer readable instructions embodied in a computer readable medium for performing the method.

### CROSS-REFERENCE TO RELATED APPLICATIONS

This application is a continuation-in-part of U.S. application Ser. No. 12/058,667 filed Mar. 29, 2008, which is hereby incorporated by reference.

### BACKGROUND

1. Technical Field

In one or more embodiments, the present invention relates to an internet lead manager and optimizer. In particular, the one or more embodiments of the present invention relate to an internet lead manager and optimizer for a vehicle dealership.

2. Background Art

The Internet has created a culture in which much of today's commerce occurs “online.” A customer may typically go “online,” prior to making a purchase, to research the product. For example, in the automobile industry, 83% of car shoppers used the Internet to research their vehicles before walking into the vehicle dealership. Knowing this, many industries have developed tools to analyze an online customer's browsing activities for market research into online consumer behavior. The prior art provides some examples of such tools. U.S. Pat. No. 6,868,389 B1 issued to Wilkins et al. is directed to Internet-enabled lead generation and provides a method of generating intender leads in a distributed computer system including the steps of identifying purchase indicators and extracting prospect identifiers from the purchase indicators. U.S. Pat. No. 7,305,364 B2 issued to Nabe et al. is directed to methods and systems for supplying customer leads to dealers and provides for methods for generating customer leads for use by dealers attempting to sell a product, for example a loan product. US Publication No. 2008/0177637 A1, Weiss et al., is directed to customer relationship management methods and systems and provides for computer implemented methods and a computer system that performs the methods that include the step or steps of receiving a plurality of orders for an item from each of a plurality of users.

To take advantage of the Internet's prominence in consumer purchases, personal communication with the customer is increasingly becoming important for customer attraction and retention. In customer-driven industries, such as the automobile dealership industry, effective and timely communication with prospective and current customers can be important particularly in already saturated industries. For example, only 10% of all prospective customers who searched for a vehicle online and contacted a dealership bought from that dealership. What is needed, therefore, is a tool for effectively communicating with clients in order to manage and optimize a business entity's client base.

### SUMMARY OF THE INVENTION

One aspect of the present invention is a computer implemented method of customer sales management over a computer network. The computer implemented method includes receiving a number of customer sales management cadence data and a number of communication tool data. The computer implemented method further includes receiving a sales lead identifier based on one or more tracked activities occurring over a computer network. The sale lead identifier identifies a priority associated with a sales lead. The computer implemented method further includes associating the sales lead identifier with the customer sales management cadence data for generating a customer sales management schedule based on the identified priority. In one embodiment, the method includes receiving a number of recommendations of schedules and selecting one of a number of recommended schedules for managing a sales lead.

The computer implemented method further includes generating a number of communication tools based on the sales lead and the sales lead identifier for managing the sales lead. The sales lead is managed through one or more communication channels. The computer implemented method further includes automatically outputting a series of communications through the one or more communication channels. The series of communications are outputted according to the customer sales management schedule thereby facilitating customer generation and retention.

Another aspect of the present invention is a computer implemented system for customer sales management comprising at least one server communicating with at least one client terminal over a computer network. The computer implemented system is adapted to receive customer sales management cadence data and communication tool data. The computer implemented system is further adapted to receive a sales lead identifier based on one or more tracked activities occurring over a computer network. The sale lead identifier identifies a priority associated with a sales lead. The computer implemented system is further adapted to associate the sales lead identifier with a number of customer sales management cadence data for generating a schedule of customer sales management cadences based on the identified priority. In one embodiment, the computer implemented system is further adapted to receive a number of recommendations of schedules and select one of a number of recommended schedules for managing a sales lead.

The computer implemented system is further adapted to generate a number of communication tools from the communication tool data based on the sales lead and the sales lead identifier. The communication tools are for use in managing the sales lead through one or more communication channels. The computer implemented system is further adapted to automatically output a series of communications through one or more communication channels according to the schedule thereby facilitating customer generation and retention.

Another aspect of the present invention is a computer program product having computer readable instructions embodied in a computer readable medium for customer sales management over a computer network. The computer program product has instructions for receiving customer sales management cadence data and communication tool data. The computer program product further includes instructions for receiving a sales lead identifier based on one or more tracked activities occurring over a computer network. The sales lead identifier identifies a priority associated with a sales lead. The computer program product further includes instructions for associating the sales lead identifier with the customer sales management cadence data for generating a customer sales management schedule based on the identified priority. In one embodiment, the computer program product further includes instructions for receiving a number of recommendations of schedules and selecting one of a number of recommended schedules for managing a sales lead.

The computer program product further includes instructions for generating a number of communication tools based on the sales lead and the sales lead identifier for managing the sales lead through one or more communication channels. The computer implemented method further includes automatically outputting a series of communications through one or more communication channels. The series of communications are outputted according to the customer sales management schedule thereby facilitating customer generation and retention.

In some embodiments, the communication tools include voice broadcasts. In other embodiments, the communication tools include text based electronic mail. In yet other embodiments, the communication tools include hypertext markup language (HTML) electronic mail. The HTML electronic mail may have streaming video integral to and playable from the HTML electronic mail.

Furthermore, in some embodiments, the sales lead identifier is a score of market readiness to purchase. In other embodiments, the sales lead identifier is a manifested interest to purchase a particular product.

These and other aspects of the present invention will be better understood in view of the attached drawings and the following detailed description of the preferred embodiments.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings, which:

FIG. 1 shows an exemplary computer system representing an internet lead manager and optimizer according to one of the various embodiments of the present invention.

FIG. 2 shows a method of operation of the internet lead manager and optimizer according to one of the various embodiments of the present invention.

FIG. 3 shows an exemplary graphical user interface (GUI) displayed to a user (e.g., sales person) according to one of the various embodiments of the present invention.

FIGS. 4A, 4B and 4C show one of the various exemplary embodiments of an automated schedule flow for sending a series of communications to a sales lead.

FIGS. 5A and 5B show various embodiments of a GUI illustrating one of the various features of the present invention for displaying to a user.

FIG. 6 shows one of the various exemplary embodiments of a message sent to a sales lead.

### DETAILED DESCRIPTION OF THE PREFERRED EMBODIMENTS

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

It goes unstated that the key to any business is a growing customer base which leads to further profits. For this reason, customer management is integral to most organizations' business activities. To attract and keep customers, such businesses will discern the interests of a customer market in order to meet those interests. What is important, however, is to effectively follow up with these customers particularly when the customer interest in a product appears to be high. For example, in the automobile industry, 55% of all consumers who shopped for a vehicle online ultimately ended up purchasing a vehicle. More specifically, 24% of these online vehicle shoppers purchased a vehicle within 10 days of shopping online while 32% purchased a vehicle within 90 days of shopping online. While these statistics are significant, they can be improved. Thus, what is needed is a tool that can manage and optimize customer management through timely and proper follow up particularly with customers showing keen interest in a product.

In one or more embodiments, the present invention is directed at an internet lead manager and optimizer. While the various embodiments are presented in the context of a vehicle dealership, such embodiments may also be useful for customer management in any other customer-driven or sales-driven industry.

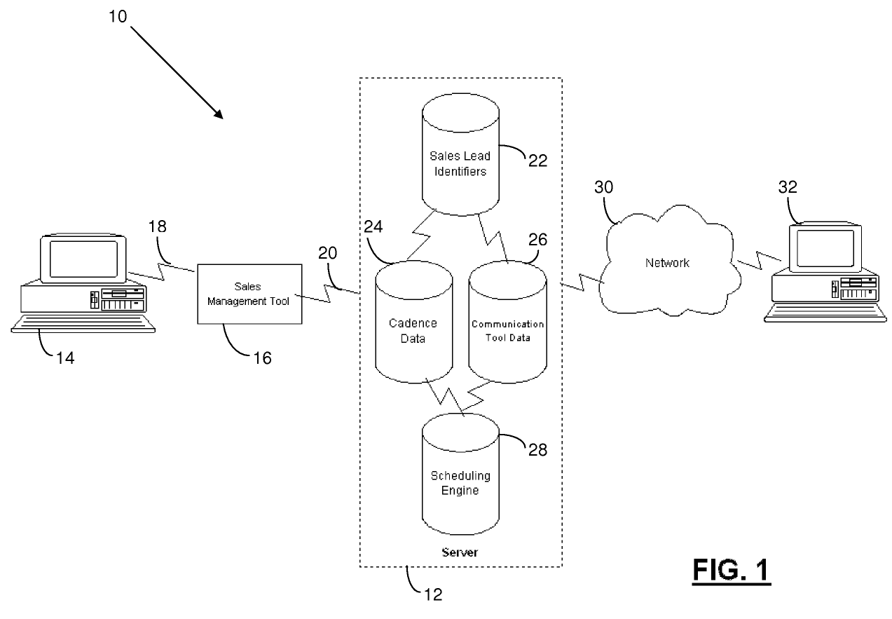

FIG. 1 shows an exemplary computer system representing an internet lead manager and optimizer according to one of the various embodiments of the present invention. Computer system 10 may have at least one server 12 in communication with at least one client terminal 14. A sales management tool (hereinafter referred to as tool 16) may be in communication with client terminal 14 through communication link 18 within client terminal 14. For example, tool 16 may be stored in persistent memory. Tool 16 may be in communication with server 12 through communication link 20 (e.g., network communication or data communication) in order to access data. In another embodiment, client terminal 14 may be a thin client and/or may be in communication with tool 16 stored in server 12. Client terminal 14 may be used to output a series of communications to user terminal 32 through one or more communication channels (e.g., Broadband or telephone) for facilitating customer generation and retention.

Server 12 may be in communication with one or more data files for data retrieval and transmission. For example, data file 22 (e.g., sales lead identifiers) may include data relating to sales lead identifiers for identifying sales leads received from user terminal 32 through network communication 30 (e.g., the Internet). Non-limiting examples of sales lead identifiers include an in market readiness of a consumer to purchase a product (e.g., a vehicle), a manifested interest by a sales lead for a particular product (e.g., a vehicle), or a trade cycle status of a vehicle (i.e., the readiness of a consumer to trade in a vehicle). As is known in the prior art, sales lead identifiers (e.g., in market readiness) are algorithmically determined based on a potential customer's (i.e., sales lead's) online activity. Typically, in the case of the in market readiness of a customer, the sales lead is given a rating, for example, on a scale of 1 to 10, in which 1 means that the sales lead is not ready to make a purchase immediately while a 10 means the sales lead is ready to buy immediately. Sales lead identifiers may be calculated through external third-party programs (e.g., POLK'S LEAD SCORING manufactured by R.L. Polk and Co.). The information identified through this analysis may be stored in data file 22 for each sales lead. In other cases, a sales lead identifier may be identified more dynamically. For example, in the case of a manifested interest in a particular product, the identifier may be generated by monitoring the sales lead's click-throughs.

Server 12 may also be in communication with data file 24 (e.g., cadence data) and data file 26 (e.g., communication tool data). In one embodiment, data file 24 may include data relating to the various time intervals for sending a series of communications to a sales lead. As will be further described below, the time intervals may be one data set used to generate a schedule of communications to be sent to the sales leads. Data file 26 may include data associated with various communication tools. For example, data file 26 may include a number of templates for use when sending a series of communications to the sales leads using a number of communication tools. Non-limiting examples of communication tools may include electronic mail (e.g., text-based and/or hypertext markup protocol language (HTML) based), voice broadcast and short messaging service (SMS) (i.e., text messaging). As will be further described below, data in data file 26 may be one data set used to generate a schedule of communications to the sales leads.

Server 12 may also be in communication with data file/engine 28 (e.g. scheduling engine). Engine 28 may manipulate data from data files 24 and 26 to generate a schedule of customer sales management cadences. The schedules may be seamlessly generated through computer readable instructions stored in engine 28. In one embodiment, schedules of customer sales management cadences may be stored as templates in another data file (not shown) in communication with engine 28 and data file 24 and 26 to generate the schedules.

Computer system 10 may also include a network connection 30 (e.g., the Internet) to a user terminal 32. User terminal 32 may be used by a sales lead (e.g., prospective customer) whose activity (e.g., over the World Wide Web) is tracked and stored in data file 22 as a sales lead identifier. For example, the amount of click-throughs on a webpage, the number of visits on particular webpages, or the products and/or services that are researched or purchased may be the activities tracked to generate a sales lead identifier. As will be described in further detail below, the data received from user terminal 32 and stored in data file 22 is used to manage sales leads.

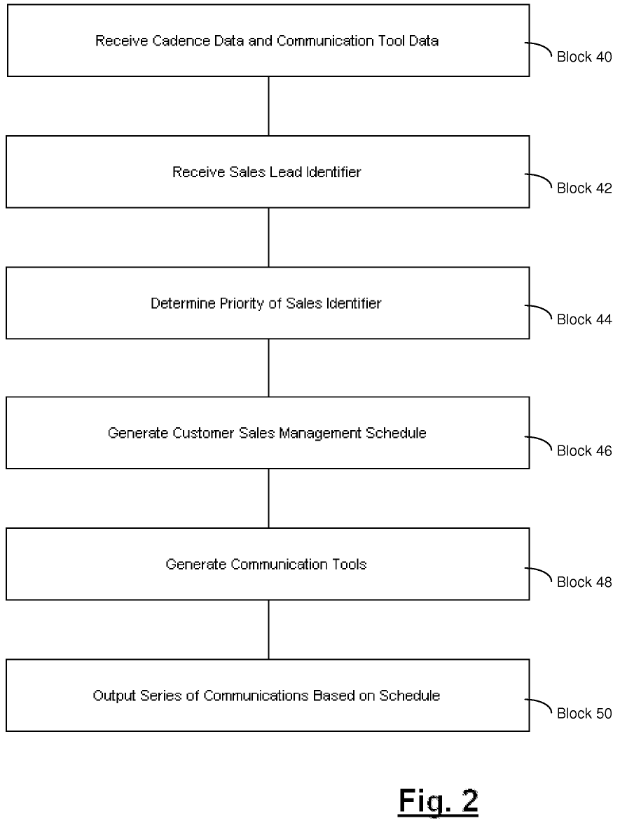

Tool 16 is a computer program product with computer readable instructions on a computer readable medium (e.g., Disk, CD, Flash memory, random access memory (RAM)). Tool 16 may include instructions programmed in any language known to one of ordinary skill in the art to achieve the various embodiments of the present invention. Tool 16 may be used for customer sales management using a sales lead identifier generated through a computer network (e.g., the Internet). Tool 16 may be in communication with server 12 through communication link 20 for managing customer sales. In one embodiment, server 12 may or may not be a separate terminal. Furthermore, tool 16 may have computer readable instructions for operating the internet lead manager and optimizer. The operation of the internet lead manager and optimizer will be further described below with respect to FIG. 2.

FIG. 2 shows a method of operation of the internet lead manager and optimizer according to one of the various embodiments of the present invention. In block 40, cadence data and communication tool data may be received at client terminal 14. In one embodiment, cadence data and communication tool data may be stored in data file 24 and 26, respectively, as raw data and tool 16 may be programmed to receive the data.

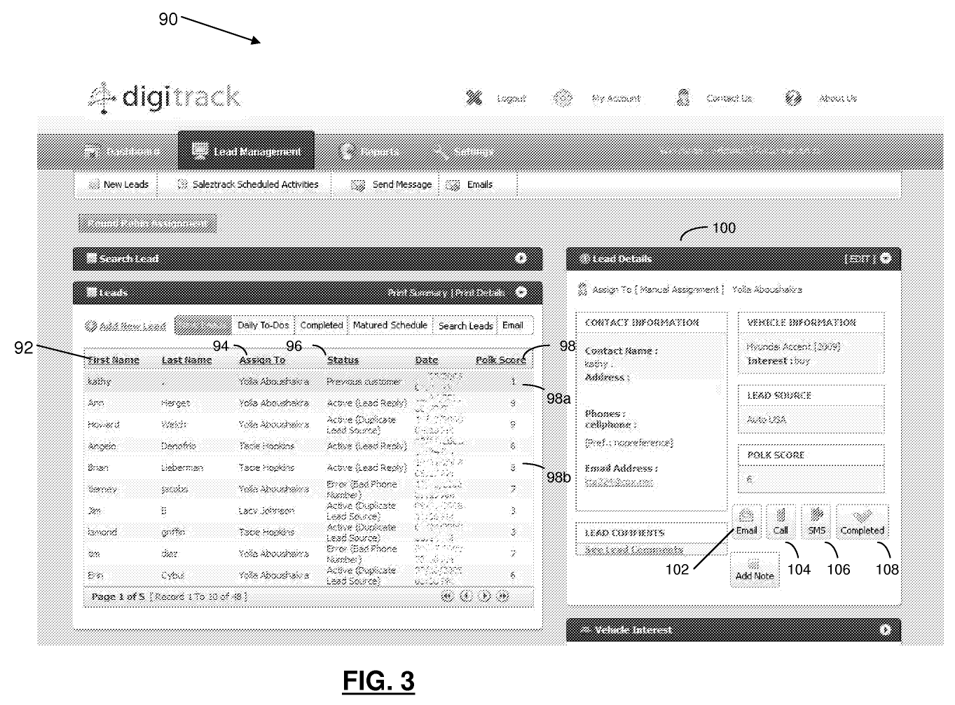

As exemplified above, a user may browse the World Wide Web (WWW) from user terminal 32 and their activity may be tracked to identify a sales lead identifier. For example, user activity may be tracked as it relates to shopping for or researching automobiles. After monitoring the user's behavior, a sales lead identifier may be then received as in block 42. The received sales lead identifier may be stored in data file 22. In one embodiment, tool 16 may be customized to receive particular types of sale lead identifiers. Non-limiting example include a sales lead's in market readiness to purchase a product (e.g., a vehicle), a particular product in which a sales lead appears to have an interest, or the trade cycle status of a particular consumer. The sales lead identifier may identify a priority given to the sales lead. For example, assuming that the sales lead identifier is an in market readiness to purchase a vehicle, a sales lead who is identified as a 10 (i.e., is willing to buy immediately) may be identified as the highest priority by tool 16 for follow-up by a dealership salesperson. Accordingly, a priority is determined for the sale lead identifier as in block 44. FIG. 3 shows an exemplary graphical user interface (GUI) for representing the identified sales lead and the identified priority given to the sales lead. FIG. 3 will be described in further detail below.

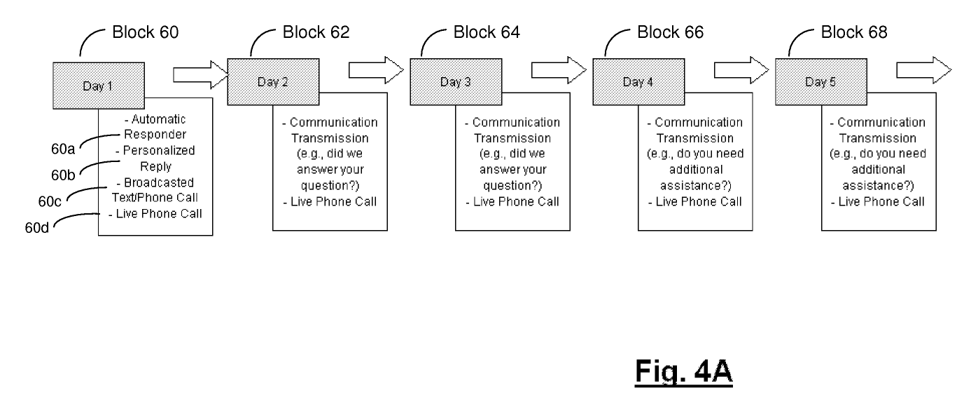

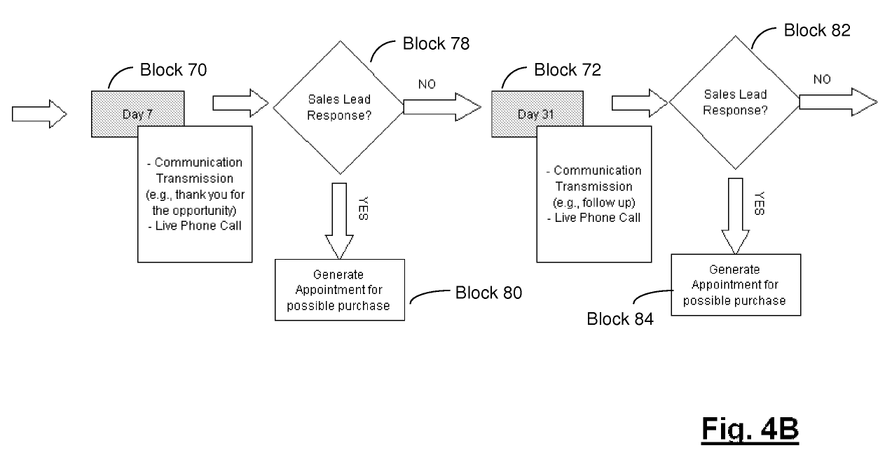

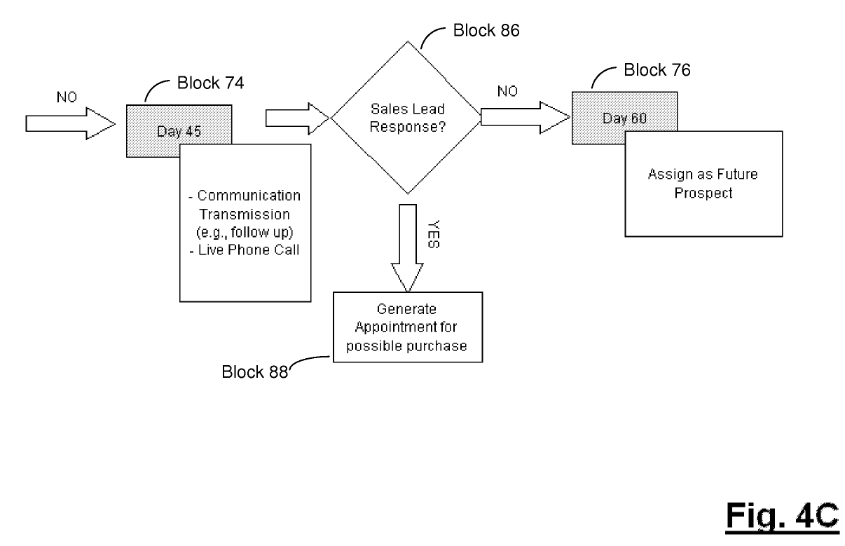

In block 46, the received sales lead identifier which identifies a priority given to the sales lead is associated with the cadence data. A schedule for sales lead management is then generated based on the priority. For example, assume the sales lead identifier is a manifested interest in a product (e.g., a vehicle) determined by, for example, the number of click-throughs on a web page about a particular product by a sales lead. In other words, the greater the number of click-throughs by the sales lead, the greater their priority. The sales lead's interest in the product is then associated or partnered with cadence data for generating a schedule of customer sales management cadences for the particular product. The schedule may be used, for example, by a vehicle dealership salesperson for following-up with prospective or current customers at designated milestones. In one embodiment, a number of recommended schedules are provided based on the sales lead identifier. Upon selection of one of the recommended schedules, the user at client terminal 14 may manage their prospective or current customers according to that schedule. One exemplary embodiment of a schedule will be described below with respect to FIG. 4.

In block 48, a number of communication tools may be generated for sending a series of communications to a sales lead through various communication channels. The communication tools may be generated based on known information about the sales lead and the sales lead identifier. Information about the sales lead may be determined from a number of sources including, but not limited to, customer history records or profile information submitted by a prospective customer. Non-limiting examples of communication tools include electronic mail (e-mail), voice broadcast, and text messaging. Thus, according to one example, a personalized e-mail having the sales lead's name may be sent to the sales lead based on their interest in a particular vehicle. In another example, a personalized voicemail addressed to the sales lead may be left on the sales lead's cell phone based on an in market readiness rating of 8 given to the sales lead.

In block 50, a series of communications are automatically outputted based on the schedule. The series of communications are outputted without human intervention using one or more communication channels. For example, the communications may be outputted through a computer network (e.g., broadband), the Internet, a telephone network, or a data network based on a predetermined schedule programmed to tool 16. The series of communications may be electronic mail, voice broadcast (e.g., telephone call), or a combination of communications. FIG. 4, as will be further described below, shows an exemplary schedule flow using a combination of communication tools over various communication channels.

FIG. 3 shows an exemplary graphical user interface (GUI) displayed to a user (e.g., sales person) at client terminal 14 according to one of the various embodiments of the present invention. GUI 90 shows the name of the sales lead 92, the sales person assigned to the sales lead 94, the sales lead status 96, and the sales lead identifier 98. For example, the sales lead identifier may be the score rating for in market readiness as represented in FIG. 3. As shown in this embodiment, the sales lead identifier may be a rating of 1 to 10 of in market readiness to purchase a product (e.g., a vehicle). Thus, a “1” score 98a may indicate that the sales lead should be given a low priority while an “8” score 98b may indicate that the sales lead should be given a higher priority for possible immediate follow up by a sales person. GUI 90 may also show information specific to a sales lead as in GUI area 100 including, for example, the type of product in which they have an interest. This combination of this priority information 98 with information in GUI area 100 may provide the basis for generating communication tools for output to the sales lead relating to the product in which the sale lead has an interest. Furthermore, the information may be the basis for determining the schedule type and the schedule timing for achieving sales lead management. GUI 90 may also include a number of selectable buttons 102, 104, 106 for non-automatic contact with the sales lead. GUI 90 may also include a selectable button for marking the completion of the management of a sales lead 108.

FIGS. 4A, 4B, 4C show one of the various exemplary embodiments of an automated schedule flow for sending a series of communications to a sales lead. In one embodiment, instructions may be included in tool 16 to recommend a number of schedules of which one may be selected by a user from client terminal 14. A series of communications will then be sent according to the selected schedule. As shown in FIGS. 4A, 4B and 4C, according to one embodiment, a series of communications may be sent on days 1 through 5 and day 7 after the sales lead's virtual visit to the dealership's website and/or electronically contacting the dealership. It should be understood that the schedule illustrated in FIGS. 4A, 4B, and 4C is merely exemplary and that the schedule may span a shorter or longer period. On day 1, as represented by block 60 (FIG. 4A), an automated message 60a may be sent to the sales lead via one of the communication channels (e.g., electronic mail) to initiate management of the sales lead. For example, the automated message may introduce the sales lead to the dealership and provide contact information for the dealership. In one embodiment, the automated message is a personalized message to the sales lead. In another embodiment, there may be a number of personalized automated messages from which a sales personnel can select to be sent to the sales lead.

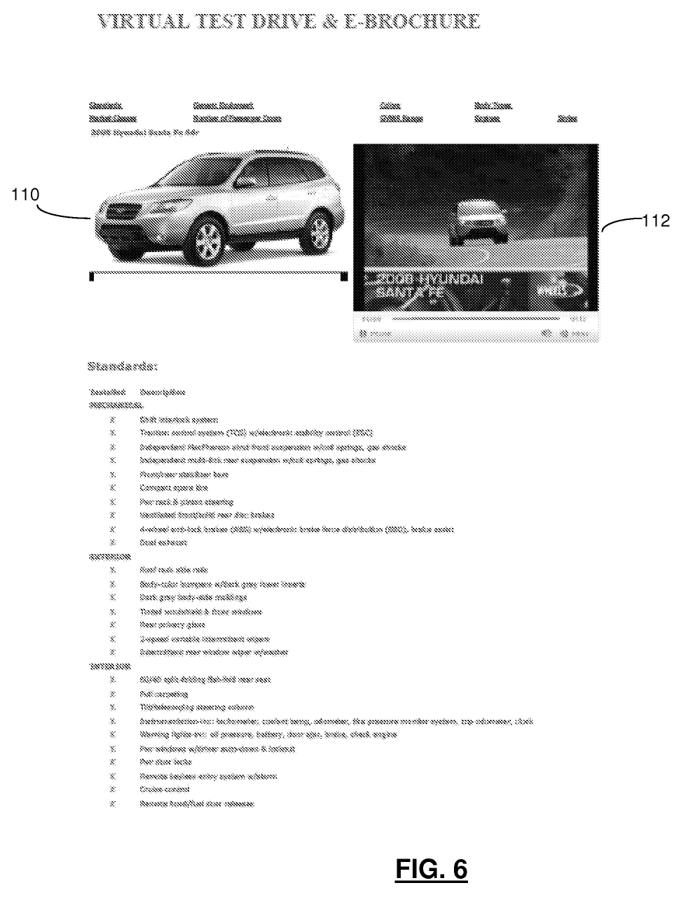

Another message 60b may then be sent to the sales lead. The message 60b may be sent as a text message or an electronic mail message. The message may be further customized and include specific details relevant to the sales lead such as details on the particular vehicle in which the sales lead has an interest. In one embodiment, the personalized message 60b may include multimedia such as videos (e.g. WMV, MPEG, MOV), pictures (e.g. GIF, JPG) or a combination of multimedia integral with and relating to the interested product. FIG. 6 represents one of the various exemplary embodiments of a personalized message including multimedia content sent to a sales lead in which a picture 110 and video 112 relate to a particular vehicle about which a sales lead has inquired or shown some interest. The video 112 may be playable from the message with or without generating a new window for playback.

Additionally, a text message or phone call may be transmitted 60cto a sales lead. In one embodiment, the text message may provide for interactive functionality with the user. The phone call may be automated 60c or may be made by a live operator 60d. In one embodiment, there may be both an automated phone call and a live phone call. It should be understood that the series of communications 60a, 60b, 60c, 60d may not be mutually exclusive nor transmitted in a particular order. That is, one, some, or all of the communications may be sent to a sales lead and in different combinations.

In blocks 62, 64, 66, 68 additional communications are transmitted to and received by the sales lead. As represented in FIG. 4A, the additional communications may occur on a daily basis. Furthermore, each communication may or may not include a live telephone call. In one embodiment, each communication requires a live phone call in order to activate and/or continue the automated communications. In another embodiment, the user (e.g., a sales person) may completely suspend the live operator requirement. In block 70 (FIG. 4B), a concluding communication may be outputted to the sale lead, for example, on the 7^{th} day. In one embodiment, transmission of the communication in block 70 may or may not be dependent upon whether there was a response from the sales lead to the communications sent by the user (e.g., a vehicle dealership). If there is a positive response by the sales lead as in block 78, the user (e.g., sale person) can generate an appointment with the sales lead for an in-person conversation and purchase opportunity as in block 80. If there is a negative response or no response as in block 78, there may be instructions in tool 16 to output further communications at a later predetermined date. For example, the next communication may be outputted on the 31st day as in block 72. If there is a positive response from the sales lead as in block 82, the user (e.g., sale person) can generate an appointment with the sales lead for an in-person conversation and purchase opportunity as in block 84. If there is a negative response or no response as in block 82, there may be further instructions in tool 16 to output further communications on another date, for example, on the 45^{th} day as in block 74 (FIG. 4C). If there is a positive response from the sales lead as in block 86, the user (e.g., sale person) can generate an appointment with the sales lead for an in-person conversation and purchase opportunity as in block 88. If there is a negative response or no response as in block 86, there may be further instructions in tool 16 to store the sales lead, after the passage of a predetermined time (e.g., the 60^{th} day) as a prospect for future follow up as in block 76.

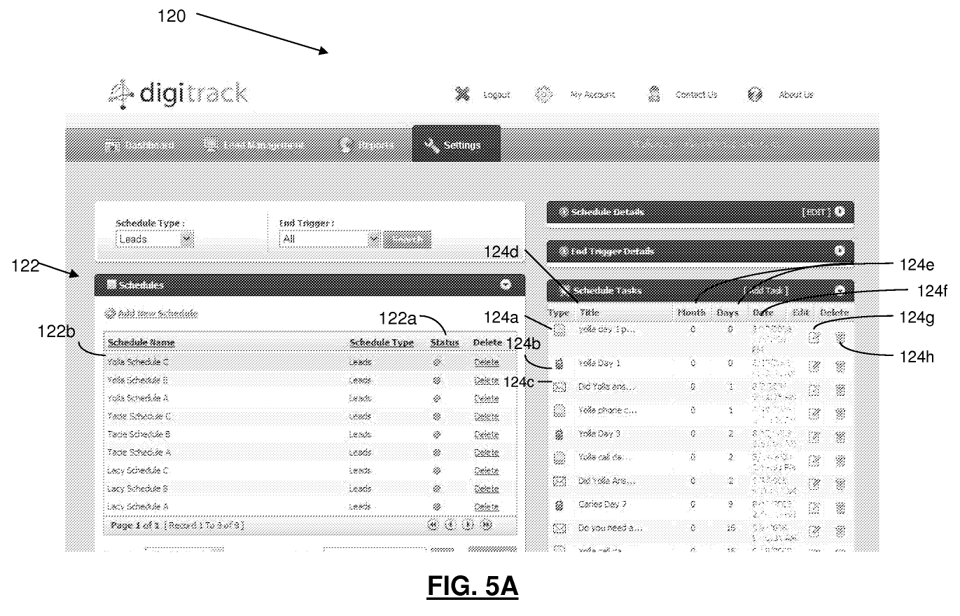

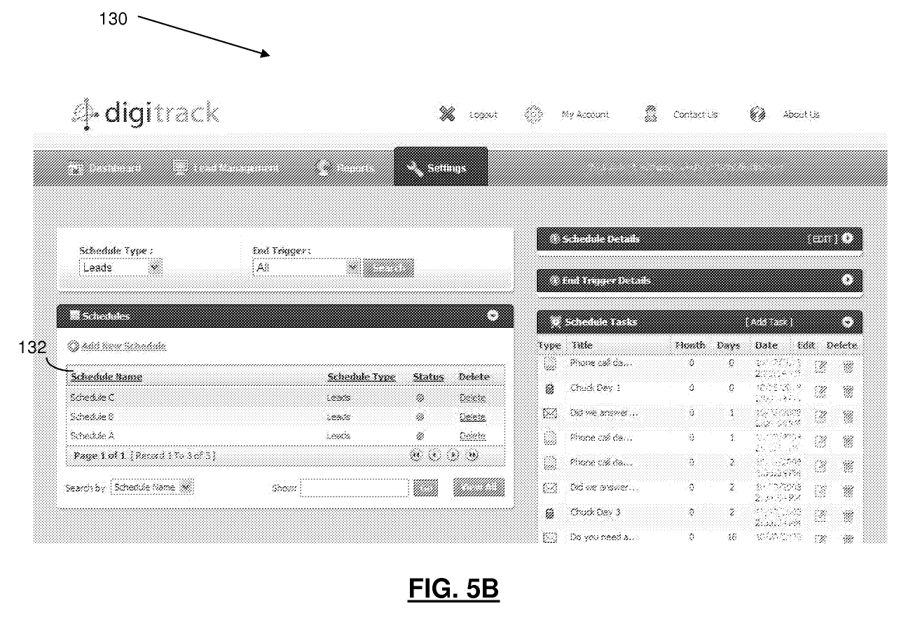

In one embodiment, the schedule may be displayed as a GUI to the user at client terminal 14. FIGS. 5A and 5B show exemplary embodiments of two GUIs for displaying a schedule to a user at client terminal 14 according to the various embodiments of the present invention. GUI 120 of FIG. 5A represents a schedule that may be displayed, for example, to an administrator such as a manager. GUI 120 may include frame 122 which may display the schedules assigned to one or more sales personnel according to the sales lead information and the sales lead identifier as described above. The administrator or manager may have control over the sales personnel's schedules such as modifying, deleting, or viewing the schedule. Frame 122 may further include a status indicator 122a for each schedule representing the status of each schedule (e.g., active or inactive).

GUI 120 may also include frames 124 and 126 which may include further information about each sales person's schedule. For example, frame 124 may display the scheduled tasks under schedule C for the sales person “Yolla” as represent in 122b. The scheduled tasks may provide information regarding the manner of sales lead management including, but not limited to, the communication tool used 124a-124c, the content of the communication tool 124d, the aging of the communication (i.e., number of months and/or days) 124e, the date of the communication 124f, and options to edit 124g and/or delete 124h the communications. The communication tools may include, but are not limited to manual follow up (i.e., live phone call) 124a, voice broadcast 124b, and/or electronic mail 124c. In one embodiment, the communication tools 124a-124c may be represented by graphical icons (as shown in FIG. 5A). In another embodiment, the communication tools 124a-124c may be represented by text (not shown). Frame 126 may include specific information about the schedule including, but not limited to, the name of the schedule (e.g., schedule A, B, or C) and the in market readiness score associate with the schedule.

GUI 130 of FIG. 5B represents another exemplary embodiment of a schedule interface for displaying to a user at user terminal 14. For example, GUI 130 may be the display presented to a dealership sales person. The content, functionality, and layout of GUI 130 may be similar to the content, functionality and layout of GUI 120 except that frame 132, unlike frame 122, may display a number of schedules assigned only to that sales person (i.e., it will not display the schedules of other sales personnel).

In one embodiment, tool 16 may include a productivity manager for monitoring the management of a sales lead by a user (e.g., sales person). For example, tool 16 may include instructions for monitoring the timeliness of a user in responding to sales lead inquiries. If the user does not respond to the inquiry according to the schedule (e.g., by placing a telephone call or sending an electronic mail message), a notification may be sent to a supervisor or manager regarding the user's tardiness. In this way, efficient and productive sales lead management may be further achieved.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer implemented method of customer sales management over a computer network, the computer implemented method comprising:
receiving a plurality of customer sales management cadence data and a plurality of communication tool data;
receiving a sales lead identifier based on one or more tracked activities occurring over a computer network wherein the sale lead identifier identifies a priority associated with a sales lead;
associating the sales lead identifier with the plurality of customer sales management cadence data for generating a schedule of customer sales management cadences based on the identified priority;
generating a plurality of communication tools from the received communication tool data based on the sales lead and the sales lead identifier for managing the sales lead through one or more communication channels; and
automatically outputting a series of communications through the one or more communication channels according to the schedule of customer sales management cadences for facilitating customer generation and retention.

2. The computer implemented method of claim 1 wherein the plurality of communication tools includes voice broadcast.

3. The computer implemented method of claim 1 wherein the plurality of communication tools includes text based electronic mail.

4. The computer implemented method of claim 1 wherein the plurality of communication tools includes hypertext markup language (HTML) electronic mail having streaming video integral to and playable from the HTML electronic mail.

5. The computer implemented method of claim 1 wherein the sales lead identifier is a score of market readiness to purchase.

6. The computer implemented method of claim 1 wherein the sales lead identifier is a manifested interest to purchase a particular product.

7. The computer implemented method of claim 1 wherein associating the sales lead identifier with the customer sales management cadence data for generating a schedule further includes receiving a plurality of recommendations for schedules based on the identified priority and selecting one of the plurality of recommended schedules for managing the sales lead.

8. A computer implemented system for customer sales management comprising at least one server communicating with at least one client terminal over a computer network, the computer implement system being adapted to:
receive a plurality of customer sales management cadence data and a plurality of communication tool data;
receive a sales lead identifier based on one or more tracked activities occurring over a computer network wherein the sale lead identifier identifies a priority associated with a sales lead;
associate the sales lead identifier with the plurality of customer sales management cadence data for generating a schedule of customer sales management cadences based on the identified priority;
generate a plurality of communication tools from the received communication tool data based on the sales lead and the sales lead identifier for managing the sales lead through one or more communication channels; and
automatically output a series of communications through the one or more communication channels according to the schedule of customer sales management cadences for facilitating customer generation and retention.

9. The computer implemented system of claim 8 wherein the plurality of communication tools includes voice broadcast.

10. The computer implemented system of claim 8 wherein the plurality of communication tools includes text based electronic mail.

11. The computer implemented system of claim 8 wherein the plurality of communication tools includes hypertext markup language (HTML) electronic mail having streaming video integral to and playable from the HTML electronic mail.

12. The computer implemented system of claim 8 wherein the sales lead identifier is a score of market readiness to purchase.

13. The computer implemented system of claim 8 wherein the sales lead identifier is a manifested interest to purchase a particular product.

14. The computer implemented system of claim 8 wherein associating the sales lead identifier with the customer sales management cadence data for generating a schedule further includes receiving a plurality of recommendations for schedules based on the identified priority and selecting one of the plurality of recommended schedules for managing the sales lead.

15. A computer program product having computer readable instructions embodied in a computer readable medium for customer sales management over a computer network, the computer program product comprising instructions for:
receiving a plurality of customer sales management cadence data and a plurality of communication tool data;
receiving a sales lead identifier based on one or more tracked activities occurring over a computer network wherein the sale lead identifier identifies a priority associated with a sales lead;
associating the sales lead identifier with the plurality of customer sales management cadence data for generating a schedule of customer sales management cadences based on the identified priority;
generating a plurality of communication tools from the received communication tool data based on the sales lead and the sales lead identifier for managing the sales lead through one or more communication channels; and
automatically outputting a series of communications through the one or more communication channels according to the schedule of customer sales management cadences for facilitating customer generation and retention.

16. The computer program product of claim 15 wherein the plurality of communication tools includes voice broadcast.

17. The computer program product of claim 15 wherein the plurality of communication tools includes text based electronic mail or hypertext markup language (HTML) electronic mail having streaming video integral to and playable from the HTML electronic mail.

18. The computer program product of claim 15 wherein the sales lead identifier is a score of market readiness to purchase.

19. The computer program product of claim 15 wherein the sales lead identifier is a manifested interest to purchase a particular product.

20. The computer program product of claim 15 wherein associating the sales lead identifier with the customer sales management cadence data for generating a schedule further includes receiving a plurality of recommendations for schedules based on the identified priority and selecting one of the plurality of recommended schedules for managing the sales lead.
